(19) United States
(12) Patent Application Publication
(10) Pub. No.: US 2008/0156873 A1
(43) Pub. Date: Jul. 3, 2008

(54) Method And System For Using Contactless Payment Cards In A Transit System

(76) Inventors: Burt A. Wilhelm, Levittown, NY (US); Oliver Steely, Bedfordshire (GB); Adam Gluck, Ardsley, NY (US)

Correspondence Address: BAKER BOTTS L.L.P., 30 ROCKEFELLER PLAZA, 44TH FLOOR, NEW YORK, NY, 10112-4498, US

(21) Appl. No.: 11/940,443

(22) Filed: Nov. 15, 2007

Related U.S. Application Data
(63) Continuation of application No. PCT/US2006/018787, filed on May 16, 2006.
(60) Provisional application No. 60/681,513, filed on May 16, 2005.
(60) Provisional application No. 60/717,626, filed on Sep. 16, 2005.

(51) Int. Cl. G07B 15/02

(52) U.S. Cl. 235/384

(57) ABSTRACT

An automatic fare collection solution for a transit system exploits the use of smart payment cards (e.g., MasterCard's PayPass cards) by the commercial payment card industry. The smart payment cards that are issued by commercial card issuers and banks to customers conform to a common or open industry standard such as the ISO 14443 standard for contactless payment cards. A cardholder seeking access to transit services presents his or her smart card to an RFID-enabled card reader at a transit system entrance. The cardholder is granted quick access unless his or her smart card is list of “hot” cards (i.e., lost or stolen, expired or delinquent cards). A card transaction record is prepared and communicated from the card reader to a transit payment platform. The transit payment platform is linked by conventional payment-by-card electronic networks to card issuers and banks for authorization, clearing and settlement of the card transaction.

### CROSS-REFERENCE TO RELATED APPLICATIONS

This application claims the benefit of International Patent Application No. PCT/US2006/018787, which was filed May 16, 2006 claiming priority from U.S. provisional patent application No. 60/681,513 filed on May 16, 2005, and U.S. provisional patent application No. 60/717,626 filed on Sep. 16, 2005, all of which applications are incorporated by reference in their entireties herein.

### BACKGROUND OF THE INVENTION

Smart card technology is fast becoming commonplace in our culture and daily lives. A smart card is a card that is embedded with either a microprocessor and a memory chip or only a memory chip with non-programmable logic. The microprocessor card can add, delete, and otherwise manipulate information on the card, while a memory-chip card (for example, pre-paid phone cards) can only undertake a pre-defined operation. Smart cards, unlike magnetic stripe cards, can carry all necessary functions and information on the card. Therefore, they do not require access to remote databases at the time of the transaction.

Smart cards, which are also generally referred to by the industry as “microprocessor cards” or “chip cards”, offer greater memory storage and security of data than a traditional magnetic stripe cards. Smart cards may have up to 8 kilobytes of RAM, 346 kilobytes of ROM, 256 kilobytes of programmable ROM, and a 16-bit microprocessor. A smart card uses a serial interface and receives its power from external sources like a card reader. The processor uses a limited instruction set for applications such as cryptography. The smart cards are used for a variety of applications, especially those that have cryptography built in, which require manipulation of large numbers. Thus, smart cards have been the main platform for cards that hold a secure digital identity. The most common smart card applications are:
Credit cards
Electronic cash
Computer security systems
Wireless communication
Loyalty systems (like frequent flyer points)
Banking
Satellite TV
Government identification

Delivering security—i.e. ensuring access is granted only for authorized usage by authorized cardholders—is the fundamental attribute of smart cards. The effectiveness of smart cards in delivering security is one of the reasons they have been so widely adopted, especially in financial services and mobile phones, why the growth of smart cards has been explosive, and why their usage is expected to expand rapidly for other applications such as personal identity cards, access to pay TV/entertainment, health care services and transportation.

Transportation or transit systems including rail, metro, bus, ferry and tolls are utilized by hundreds of millions of people the daily. Cost effective, efficient and reliable transit is a civic necessity in modern metropolitan areas. Smart cards can advantageously remove notes and coins from the transit environment. Not only are smart card payments fast and reliable but they also help to reduce the cost of equipment maintenance. Leading transit systems around the world are moving to new payments mechanisms based upon smart card technology.

Several RFID technologies are available for use in contactless smart card and card readers/terminals. The basic components of a contactless system are the contactless reader (or Proximity Coupling Device (PCD)) and a transponder. The contactless reader is an antenna connected to an electronic circuit. A transponder consists of an inductive antenna and an integrated circuit connected to the ends of this antenna. The combination reader-transponder behaves as a transformer. An alternating current passes through a primary coil (reader antenna) that creates an electromagnetic field, which induces a current in the secondary coil (transponder antenna). The transponder converts the electromagnetic field (or RF field) transmitted by the contactless reader (PCD) into a DC voltage by means of a diode rectifier. This DC voltage powers up the transponder's internal circuits. The configuration and tuning of both antennas determines the coupling efficiency from one device to the other. The transponders may be the contactless payment cards.

For contactless payment card systems to be economically viable and to gain commercial acceptance, the contactless payment cards must be interoperable at all or most RFID-enabled payment terminals, even when the cards and terminals have technological features that are proprietary to specific card providers/issuers, vendors or terminal manufacturers. Industry-wide interoperability is desirable. Towards this end, industry standards organizations and groups (e.g., International Organization for Standards (ISO) and International Electro Technical Committee (IEC)) have formulated voluntary industry standards for implementation of contactless smart card payment technologies. Three such exemplary standards which have been defined by ISO/IEC are the ISO/IEC 10536, ISO/IEC 14443, ISO/IEC 15693 standards applicable to Close Coupling, Proximity and Vicinity cards, respectively.

Recently, assignee MasterCard International Incorporated (“MasterCard”) has developed proprietary specifications MasterCard PayPass™ ISO/IEC 14443 Implementation Specification (“PayPass”) for implementation of proximity (contactless) payment card technologies. PayPass is a RFID-enabled contactless payment platform, which lets users tap or wave a device in front of a special reader in order to process a transaction. The PayPass implementations are consistent with the ISO 14443 Standard and provide a convenient example illustrating the principles of the present invention. See e.g., Smets et al. U.S. patent application Ser. Nos. 11/182,354, 11/182,357, 11/182,358, 11/182,356, 11/182,355, and 11/182,351, all filed Jul. 15, 2005 and all of which are incorporated by reference herein. Assignee MasterCard is a global leader in the provision of open payment solutions, which leverage the MasterCard family of brands, including credit, debit and prepaid payment solutions. In addition, MasterCard is well placed to enable Prepaid Private Label payment programs, tailored specifically to the needs of transit. The PayPass implementations are targeted at meeting the needs of merchants that require quick service and high throughput, typically for small amounts (e.g., less than fifty U.S. dollars). See e.g., MasterCard Payment Card Industry Data Security Standard, January 2005, available at https://sdp.mastercardintl.com/pdf/pcd_manual.pdf, which and MasterCard's Security Rules and Procedures, July 2005 Revised August 2005, available at www.mastercardmerchant.com/acquirers/index.html, both of which publications are incorporated by reference in their entireties herein. Additional public documentation on PayPass features is available at https://mbe2stl101.mastercard.net/hsm2stl101/public/login/ebusiness/mobile_commerce/paypass/documentation/index.jsp

Consideration is now being given to enhancing payment solutions that are utilized in transit system environments. Desirable payment solutions are “open” solutions, i.e. in which users are able to access the transit system using contactless access cards specific to a transit system and/or smart cards that have broad commercial use beyond the transit system.

### SUMMARY OF THE INVENTION

The present invention provides automatic fare collection (AFC) systems and methods for transit systems.

An exemplary AFC system is based on the use of RFID-enabled contactless payment cards issued by commercial card issuers. The RFID-enabled contactless payment cards conform to open industry standards (e.g., ISO 14443 Standard) for contactless payment cards. The AFC system includes RFID-enabled card readers disposed at entrances to the transit system pay areas and a transit payment platform. The RFID-enabled card readers may be interfaced with a terminal or station controller. The AFC system further includes a transit payment platform or application designed to conduct transaction payment authorization, clearing and settlement processes over electronic networks common in the payment-by-card industry. A customer desiring to gain access to gated pay areas of the transit system presents his or her contactless payment card (e.g., MasterCard's PayPass card) to be read by the. The RFID-enabled card reader for fare payment. The card reader/terminal controller evaluate the read contactless payment card data against a list of hot cards (i.e., cards that reported lost, stolen, expired, or delinquent in payments) and accordingly grant or deny the customer access to gated pay areas of the transit system. A card transaction record is prepared an communicated to the transit payment platform for payment authorization, clearing and settlement. For single fare rides, the transaction payments are charged to the customer's card account (e.g., credit or debit account) with the card issuer.

The transit payment platform can be further configured so that customers can register or set up pre-funded transit accounts linked to their contactless payment cards. The pre-funded accounts may be have currency balances (e.g., dollar amounts), ride entitlement balances (e.g., number of rides) or time balances, which correspond, for example, to pay-per-ride ticket, maximum number of rides per ticket, and unlimited ride ticket fares. For fare transactions with such contactless payment cards, the transit payment platform settles the transaction payments against the pre-funded transit accounts associated with the transacting customers' contactless payment cards.

Further features of the invention, its nature and various advantages will be more apparent from the accompanying drawings and the following detailed description.

### BRIEF DESCRIPTION OF THE DRAWINGS

FIG. 1 is a block diagram illustrating the logical elements of an electronic payment solution for a transit system, in accordance with the principles of the present invention.

FIG. 2 is a block diagram illustrating an exemplary automated fare collection architecture for a transit system based on the use of PayPass cards for fare payment, in accordance with the principles of the present invention.

FIG. 3 is schematic diagram illustrating the components of a smart card payment platform which is interfaced a transit system infrastructure for automatic fare collection, in accordance with the principles of the present invention.

FIG. 4 is flow diagram illustrating the exemplary steps involved in a process for registering a customer's smart card for use in a transit system, in accordance with the principles of the present invention.

FIG. 5 is flow diagram illustration the exemplary steps involved in a process for processing a fare transaction when a customer presents a smart card at a transit system's card reader for fare payment, in accordance with the principles of the present invention.

### DETAILED DESCRIPTION OF THE INVENTION

The present invention provides an automatic fare collection (AFC) solution for transit systems. This AFC solution, which is based on the use of smart cards, allows automatic fare collection systems and procedures to be implemented in a transit system. The automatic fare collection systems and procedures can advantageously reduce operating costs by reducing, for example, currency handling costs, ticket vending machine and turnstile maintenance costs, fare media procurement costs (e.g., plastic/paper fare cards), and the number of staffed ticket booths in operation. The AFC solution is based on smart cards (e.g., MasterCard's PayPass) that conform to a common or open industry standard (e.g., ISO 14443 Standard) for contactless payment devices.

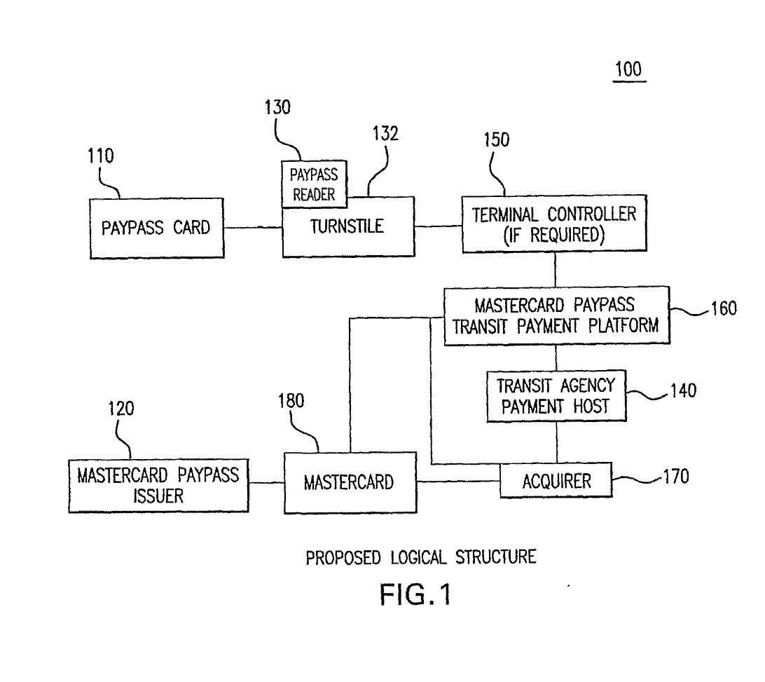

FIG. 1 is a block diagram, which shows the logical and structural components of an exemplary electronic payment solution 100 for a transit system. Exemplary electronic payment solution 100 is based on Master Card's PayPass implementations. In solution 100, a cardholder is issued a PayPass card 110 by an issuer 120. The customer can present the PayPass card to pay fares, for example, at a turnstile 132 (e.g., a subway turnstile or gate), to gain entry to gated pay areas of the transit system. Turnstile 132 is provided with a RFID-enabled card reader 130 for electronically reading the PayPass card presented by the customer for automated flare collection (AFC). Card reader 130 is electronically linked to a transit system's payment host 140 via an optional terminal controller 150 and a PayPass Transit Payment Platform 160. The customer's fare payment may be electronically processed in a manner similar to the present payment-by-card schemes that are used to process PayPass credit or debit card payment transactions, for example, in the retail industry. For this purpose, Transit Agency Payment Host 170 is linked to card issuer 120 and other entities or organizations via a conventional payment-by-card electronic network 190. The transaction payment processing steps (e.g., transaction/payment authorization request, approval, and settlement steps) may involve conventional electronic payment infrastructure entities such as an acquirer 170 and the PayPass card association 180 (i.e. MasterCard) who are also linked by network 190.

In an implementation of payment solution 100, customers may set-up and register pre-funded transit accounts, which are linked to the customers' PayPass cards. In practice, a customer presents or “taps” or his or her PayPass card 110 at card reader 130 mounted on transit turnstile 132 to gain access to the gated pay areas of the transit system. Data encoded in the card is read and transmitted to terminal controller 150. Terminal controller 150 responds by either accepting or rejecting the card. The customer is accordingly given or denied access through the turnstile. Terminal controller 150 software communicates a transaction data record to PayPass Transit Payment Platform 160. PayPass Transit Payment Platform 160 provides necessary authorizations and batch settlement processing functions for transactions, as well as continued maintenance of the card terminal software.

It will be understood that the selection of the PayPass implementation for purposes of illustration is only exemplary, and that the principles of the present invention can be more generally applied to electronic payment devices and systems that operate under other common industry or proprietary standards. Other electronic payment devices and systems may be based on contactless cards such as American Express ExpressPay and Visa Wave. The PayPass implementations bring open payments to the transit environment and provide new options to transit entities that are planning to deploy, or already deploying, smart card based payment solutions. The PayPass implementations can be advantageously tailored to leverage open payment solutions to benefit both the transit entities and their customers.

Further, the application of the inventive electronic payment solution is described herein with reference to an exemplary subway transit system—NY City Transit (“NY Transit”), which is operated by the Metropolitan Transportation Authority (“MTA”) of the State of New York. It will be understood that the choice of MTA/NY Transit is only for purposes of illustration and that the inventive electronic payment solution may be utilized in any other transit systems (e.g., Staten Island Railway, Long Island Rail Road, Long Island Bus, Metro-North Railroad, and Bridges & Tunnels).

Electronic payment solution 100 may be designed for integrated AFC applications across several transit systems (e.g., subways, buses, railroads, etc.) and also may be integrated with other electronic payment solutions such as the E-ZPass solution, which is deployed in the MTA's Bridges and Tunnels operation for AFC.

With renewed reference to FIG. 1, solution 100 may be operable with any suitable number of different card types and card distribution models. The transit functionality of these different card types is enabled by suitable design of Transit Payment Platform 140.

The suitable number of card types and card distribution models may be selected with a view to extend smart card use to as wide a proportion of the transit system's ridership as makes economic sense. The selected card types may include, for example, cards that support single-ride, time based (unlimited ride) modes of operation, and/or value based cards that that support pay-per-ride modes of operation. Examples of potential card distribution models include:
(1) Bank issued cards (e.g., MasterCard PayPass)

Banks may issue PayPass enabled standard credit or debit cards for general use by cardholders at merchants. These PayPass cards may also be used for travel within a transit system (e.g., MTA system). The cards have the ability to cater to the needs of the regular commuters in addition to the infrequent travelers and visitors to the region. The cards may either be registered with the transit system to set up a pay-per-ride pre-funded transit account, which may be spent solely within the MTA environment (in a similar manner to E-ZPass). Registered PayPass cards can perform the functionality of a regular MetroCard for value based (pay-per-ride), or time based (unlimited ride) products. Unregistered PayPass cards may be used within the MTA to pay at the gate for a small number of rides each month.
(2) Transit Agency/bank co-branded cards (e.g., MTA/MasterCard PayPass co-branded MetroCard)

The co-branded cards may be marketed and issued by banks as ‘commuter’, ‘city’ or ‘travel’ cards. Within the MTA system, the co-branded cards have functionality similar to that of a regular MetroCard ticket, which is based magnetic stripe technology, for value based (pay-per-ride), or time based (unlimited ride) products. The cards will function as normal bank payment cards outside the MTA environment. All cardholders are automatically registered with the transit system for the purpose of travel, either on a value based (pay-per-ride) or time based (unlimited ride) basis according to cardholder selection at the time of enrollment.
(3) Transit Agency/private label card powered by PayPass:

The Transit Agency/private label card may target riders who are regular users of the system but who do not wish to combine their travel cards with bank payment cards. For example, the MTA and its agents may distribute these private label cards via an issuing partner. This card product has functionality similar to that that of a regular MetroCard for value based (pay-per-ride), or time based (unlimited ride) products.

The Transit Agency/private label card is a true prepaid card that may only be used within the transit agency environment (e.g., MTA environment). The MTA private label card may be appropriate for under banked customers and/or those who prefer a separate payment card for travel. Customers might pay a fee and/or deposit in order to obtain the card. All cardholders may be automatically be registered with the Transit Payment Platform for the purposes of travel, either on a value based (pay-per-ride) or time based (unlimited ride) basis.

In practice, MasterCard and its member banks will be promoting the RFID-enabled PayPass concept for speedy transactions throughout the United States. As deployment occurs in geographies other than New York City, it may be possible to begin linking up the transit capabilities available in one area with those in another. Initially, this may make most sense on a regional basis, but has the potential to be extended nation wide. Therefore, visitors from other parts of the US will be able to gain entry to the MTA systems using their existing PayPass cards. This may reduce costs for the MTA, and also improve the overall utility of the system for riders. MTA's adoption of a PayPass solution would give riders the ability to travel from Albany to NY City using their MasterCard PayPass card.

Exemplary implementations of solution 100 based on MasterCard's PayPass may be configured to be consistent or compatible with pre-existing the fare structures and card or ticket types that are used by the transit system. Appendix A shows a fare structure for MTA/NY Transit. Further, Appendix B shows in tabular form a comparison of the transit fare structure features supported by each of the three card types discussed above.

Solution 100 may be configured to support any number of AFC architectures or schemes. An exemplary AFC architecture—“Host plus Distributed Negative File,” is based on the use of standard PayPass payment cards. In this architecture, there is no need for any special transit application to be loaded onto the payment cards. A customer presents a standard PayPass card 110 to turnstile 130/reader 132 for fare collection. Turnstile 130 validates the card data (e.g., personal account number, Expiry Date, and card validation code) and checks whether the card is listed in a negative file or hot list. If the card is listed in the negative file, turnstile 130/terminal 150 deny the customer access to the gated pay areas of the transit system. Conversely, if the card is not listed in the negative file, turnstile 130/terminal 150 activates a gate to allow the customer access to the pay areas of the transit system. Turnstile 130/terminal 150 concurrently or later forwards a raw transaction data record associated with the card use to the transit payment platform 160, which may be configured to process single-ride, pay-per-ride and unlimited ride transactions. Transit payment platform 160 receives raw transactions from transit system (e.g., MTA) and processes them against registered customer accounts. Where appropriate, transit payment platform host 140 may forward the single-ride transaction data to an acquirer 170 for further processing. Transit payment platform host 140 generates and maintains the negative file, which is distributed to turnstiles 130, for example, via terminal controller 150.

Another exemplary AFC architecture—“Host plus Distributed Entitlements,” is also based on the use of standard PayPass cards. In this architecture, Transit payment platform host 140 distributes a positive file of entitlements to turnstiles 130 in the transit system. The entitlements may be represented as a list of valid unlimited ride cards, and valid value based cards that have a positive pre-funded balance. When a customer presents a standard PayPass card 110 to turnstile 130/reader 132 for fare collection, turnstile 130 validates the card data and checks whether the card is listed in the entitlement file. If the card is listed in the entitlement file, turnstile 130 activates a gate to allow the customer access to the gated pay areas of the transit system. Conversely, if the card is not listed in the entitlement file, turnstile 130 denies the customer access to the gated pay areas of the transit system. Turnstile 130 may concurrently or later forward a raw transaction data record associated with the card to the transit payment platform host 140. Transit payment platform host 140 processes transactions and updates entitlement file and balances for distribution back to turnstiles 130.

The Host plus Distributed Entitlements architecture may advantageously reduce incidents of unpaid rides that are possible with the Host plus Negative File architecture. However, the entitlement files used in the former architecture may be large. The large entitlement files may require provision of additional memory at turnstiles 130/terminal controller 150 in comparison to the memory required for the smaller negative files used in the latter architecture.

Like the Host plus Negative File architecture, the Host plus Distributed Entitlements architecture uses standard PayPass cards. There is no need for special transit application to be loaded onto cards.

Yet another exemplary architecture—“Host plus Smart Ticketing Application on PayPass Card,” uses standard PayPass cards that are enhanced with a special transit application. The special transit application records real-time rider activity and a shadow pre-funded balance. The card's pre-funded balance/entitlement may be updated by a customer, for example, at an MTA PayPass enabled vending machine. In this architecture, turnstiles 130/readers 132 are configured to read and update a rider activity record stored on the card. The records of rider activity may be used to prevent unpaid rides and abuse of unlimited ride tickets. When a customer presents a standard PayPass card 110 to turnstile 130/reader 132 for fare collection, turnstile 130 validates the card data and checks whether the card is listed in a negative file or an entitlement file. Further, automatic fare collection transaction processing may occur in a manner similar to that in the previously described two AFC architectures.

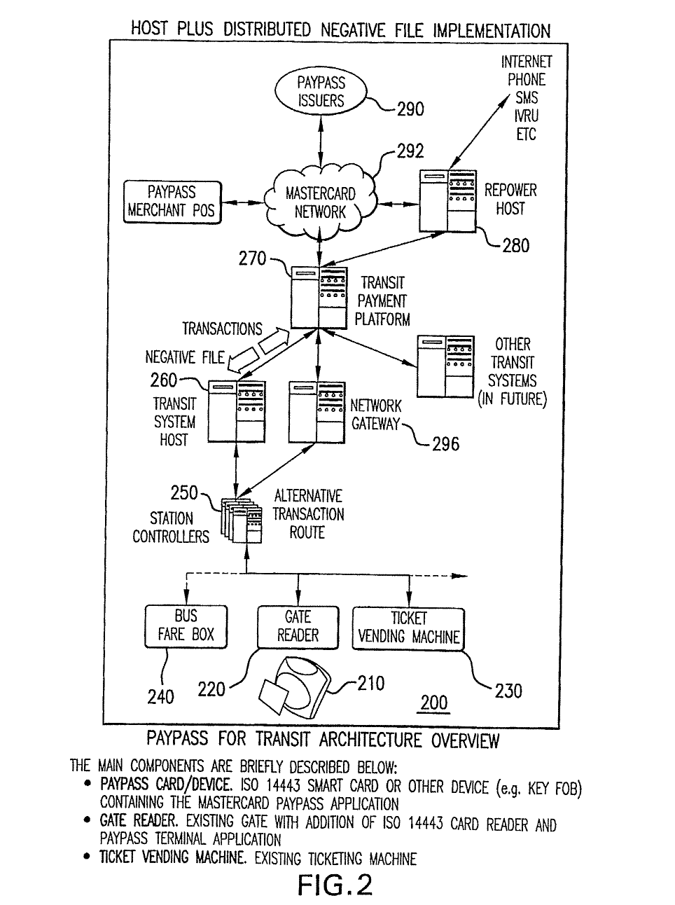

FIG. 2 shows AFC solution 200, which is an exemplary implementation of the Host plus Distributed Negative File AFC architecture in a mass transit system. The structural components of this solution include entities such as PayPass issuers 290, and software and hardware components such as a standard PayPass Card/device 210, a Gate Reader 220, Ticket Vending Machine 230, Bus Fare Box 240, station controller 250, a Transit System Host 260, a Transit Payment platform 270, PayPass Card issuers 290, a rePower Host 280 and electronic payments network (MasterCard Network 292).

In AFC solution 200, PayPass Card/device 210 may be an ISO 14443 smart card or other device (e.g. key fob) containing the MasterCard PayPass application. Gate Reader 220 may be a conventional turnstile or gate, which is augmented with an ISO 14443 card reader and a PayPass terminal application. Similarly, Bus Fare Box 240 may be a conventional bus fare box, which is augmented with an ISO 14443 card reader and a PayPass terminal application. Ticket Vending Machine 230 may be a conventional ticket vending machine, which is similar to those currently deployed by the MTA at subway stations. Station controller 250 may be a conventional station controller, which is modified to process PayPass transactions and handle the negative file. Transit System Host 260 may be an existing system host used by the MTA. Transit fare payment transactions may be routed via Host 260 and Transaction Payment Platform 270 to MasterCard Network 292, which is presently deployed to process and route MasterCard transactions in the US and world-wide. Alternatively, the fare payment transactions may be routed to MasterCard Network 292 via a separate gateway host (e.g., Network Gateway 296). Use of Network Gateway 296 as an alternate to route fare payment transactions may minimize the processing load or impact on the existing system host used by the MTA.

MasterCard Network 292 links Transit Payment Platform 270, optional rePower Host 280, PayPass Issuers 290 and PayPass Merchant PoS 294. PayPass Issuers 290 may be conventional issuers of PayPass credit or debit cards (e.g., MasterCard member banks). In FIG. 2, PayPass Merchant PoS 294 represents the point of sale infrastructure outside the MTA for merchant acceptance of MasterCard PayPass credit and debit cards (e.g. for conducting retail merchant-customer sales).

Transit Payment Platform 270 may be a host system, which is suitably configured to manage single-ride, pay-per-ride and unlimited ride transactions for the MTA/NY Transit and other transit systems (e.g., transit systems 298). Transit Payment Platform 270 receives raw transactions from the MTA Transit System Host 260 or alternate network gateway 296, and processes the raw transactions against registered cardholder accounts. Transit Payment Platform 270 may forward single-ride transactions to a third party (e.g., an acquirer) where appropriate. Further, Transit Payment Platform 270 generates or maintains a negative file, which is passed back to the MTA Transit System Host 260 for distribution to station controllers 250.

Optional rePower Host 280 may be any host system that is configured to reload value based and time based (pre-funded) card accounts automatically or in response to requests. rePower is MasterCard's branded facility for loading value to pre-funded accounts. The rePower host may have suitable interfaces that facilitate reload requests, for example, via the Internet, text message, or telephone. rePower Host 280 provides updated reload information to linked Transit Payment Platform 270.

When a customer presents PayPass Card/device 210 for fare payment, solution 200 may use an exemplary PayPass transit card processing procedure 300 for AFC according to the fare type (e.g., single ride, value based pay-per-ride, or time based). Exemplary process steps and outcomes that take place at Gate Reader 220 and/or at Transit Payment Platform 270 are listed in Table 1.

TABLE 1
PayPass transit card processing procedure 300

| | Gate Process 310 | |
|---|---|---|
| | MasterCard PayPass card read at gate (311) | |
| | Transaction will be declined if the card is on the negative file, otherwise | |
| | gate will be opened. (312) | |
| | Transit Payment Platform Process 320 | |
| | Host will determine if an unregistered or a registered card (321) | |
| | Post-funded Card | Pre-funded Card |
| | (e.g., Unregistered Card) | (e.g., Registered Card) |
| Single Ride | Payment will be obtained from a | |
| | MasterCard credit or debit account | |
| | (322) | |
| | Payment authorization performed | |
| | asynchronously (i.e. at a later time | |
| | than card presentment) 322a | |
| | If payment authorization declined, | |
| | the card will be added to the | |
| | negative file (322b) | |
| | If payment authorization OK, then | |
| | payment processed via Acquirer | |
| | (322c) | |
| | Payment deducted from | |
| | cardholder's MasterCard account | |
| | by the Card Issuer (credit, debit) | |
| | (322d) | |
| | Aggregation of transactions (for | |
| | example, by rider or account | |
| | holder) on a periodic basis to | |
| | enhance system functionality is an | |
| | option (322e) | |
| Value Based | | Payment will be obtained from the |
| (Pay-per-ride) | | cardholder's Transit Payment |
| | | Platform Account (323) |
| | | Payment check performed |
| | | asynchronously (i.e.: at a later |
| | | time than card presentment) |
| | | (323a) |
| | | If payment declined (e.g. |
| | | because of insufficient funds in |
| | | the cardholder's transit pre- |
| | | funded account), the card will |
| | | be added to the negative file |
| | | (323b) |
| | | Otherwise payment deducted |
| | | from cardholder's Transit |
| | | Payment Platform account |
| | | (323c) |
| Time Based | | Ride will be checked against |
| (Unlimited ride) | | cardholder's entitlement stored on |
| | | Transit Payment Platform account |
| | | (324) |
| | | Ride entitlement check |
| | | performed asynchronously (i.e.: |
| | | at a later time than card |
| | | presentment) (324a) |
| | | If ride entitlement declined (e.g. |
| | | because the unlimited ride |
| | | period has expired), the card |
| | | will be added to the negative |
| | | file (note if the cardholder has |
| | | selected “auto-load” on |
| | | rePower, then their entitlement |
| | | will automatically be renewed |
| | | prior to expiry) (324b) |

As shown in Table 1, PayPass transit card processing procedure 300 includes checks on the usage of PayPass cards at two stages. First, the presented card is checked against a negative file at gate 220 (step 312). Next, the presented card checked at Transit Payment Platform 320 (payment authorization steps 322a, 323a, and ride entitlement check step 324a). If either check fails, the card may be added to the negative file.

The Transit Payment Platform checks may be performed asynchronously (i.e. at a later time than card presentment). Therefore, it may be possible for a cardholder whose card clears the first “gate” check to gain access to gated pay areas of the transit system even if the later Transit Payment Platform check fails.

In addition to verifying that the presented card is not present in the negative file, the gate check performed at gate 220 (step 312) may include verification that format of the card data is correct, and that the card has not expired. The gate check also may include other verifications, for example, velocity profiling (i.e. that the presented card has not been used more than a fixed number of times in the same day at the same transit station).

Similarly, the Transit Payment Platform check may include verification that the presented card has not expired and is not on a list of cards reported as lost or stolen. For MTA Private Label cards that are reported as lost or stolen to a transit service agent, the service agent may update a Transit Payment Platform list of cards reported as lost or stolen. For MasterCard branded cards, Transit Payment Platform 270 may have access to MasterCard's global lost/stolen cards file and use that file for verification that the presented card has not reported as lost or stolen.

Transit Payment Platform 270 may be configured to conduct additional checks the transaction data records in order to implement the fare plan rules (e.g., rules concerning transfers between routes/lines). Where appropriate for the implementing such rules, Transit Payment Platform 270 may generate additional payment transactions. The checks designed to implement fare rules may depend on the type of the fare transaction. For example, for single ride transactions the additional checks may include verification that a maximum number of rides per month has not been exceeded (e.g., 10), and that the payment is authorized by the card issuer. For pay-per-ride transactions, the additional checks may include verification that the cardholder's pre-funded transit account balance is sufficient to fund the ride. For unlimited ride transactions, the additional checks may include verification that the cardholder's unlimited travel period has not expired and that the card has not been presented more than once at the same station within a restricted period (e.g., currently 18 minutes for an MTA MetroCard, which uses magnetic stripe technology).

AFC solution 200 relies on a hot list of cards (i.e., the negative file) to prevent cardholders from improperly gaining access to the system. If a card is included within the negative file, the gate to pay areas of the transit system will not open. In practice, the effectiveness of this method of preventing improper access depends on the frequency at which the negative file is updated and the distributed throughout the transit system. An updated negative file may be conveniently distributed daily. However, more frequent updates/distribution will likely reduce the incidence of unpaid fare riders.

AFC solution 200 is also configured to remove or delete card listings from the negative file when appropriate. For example, when a pay-per-ride card is loaded or an unlimited ride card is renewed, any corresponding entry in the negative file is removed. The updated negative file can take effect only after the next distribution of the negative file. In the case of a daily distribution schedule, this may mean that the pay-per-ride/unlimited ride card is valid for travel only on the following day. More frequent updates and distribution of the negative file may be desirable.

FIG. 2 shows rePower Host 280, which is MasterCard's branded facility for loading value to pre-funded transit accounts. A cardholder can register with rePower by filling in a form, via the Internet or as part of a transit account setup procedure. Following registration, the cardholder may top-up his or her pre-funded transit account via the Internet, phone, cell phone text message, e-mail or IVRU. The rePower facility also may be extended to ATMs, PoS devices, machines and possibly to existing ticketing agents.

Solution 200 may be configured to provide a cardholder with an automatic top-up option, which replenishes value to a pre-funded transit account from an associated debit or credit card when the account balance falls below a certain level. In a transaction for loading value, rePower Host 280 may first deduct fares for unpaid rides or alternatively add refunds to the designated load amount for the transit account. Further, negative file entries associated with the re-loaded card are deleted.

Similarly, when an unlimited ride ticket is purchased or renewed, any unpaid fares are added to the purchase amount. Further, negative file entries associated with the renewed unlimited ride ticket are deleted.

AFC solution 200 may affect other conventional aspects of transit system operation. However, AFC solution 200 may be modified to improve or accommodate the affected aspects. For example, under AFC solution 200 transit system riders will not have traditional paper tickets, which can be inspected by on-board train conductors. If on-board inspection is desired, solution 200 may provide portable PayPass Card readers to on-board train conductors or ticket inspectors. The portable PayPass Card readers can be used to inspect PayPass cards presented by on board riders. PayPass card information may be stored for later processing. Alternatively or additionally, the portable PayPass Card readers may be provided with mobile communication capabilities so that rider's fare entitlement or payment can be confirmed, for example, with the Transit System Host or stored for later processing.

AFC solution 200 may involve two types of settlement of transactions and payments. One type of settlement relates to single-ride transactions authorized by PayPass Issuers 290. Settlement for these transactions may be conducted via a third party (e.g., an acquirer, FIG. 1) to Transit Payment Platform and then to the MTA. Alternatively, the single ride transactions settlement may involve transaction aggregation or the use of pre-authorized amounts. Transaction aggregation, which aggregates several single-ride transactions by rider or account-holder, may provide efficient settlement.

A second type of settlement relates to transactions for rides made using pay-per-ride or unlimited ride PayPass cards. This type of settlement is conducted directly between Transit Payment Platform 270 and the MTA. A suitable commercial arrangement may be set up for this purpose between an operator of Transit Payment Platform 270 and the MTA.

It will be understood, further, that the foregoing is only illustrative of the principles of the invention, and that various modifications can be made by those skilled in the art, without departing from the scope and spirit of the invention. For example, AFC solution 200 for MTA NY Transit subways can be readily extended to MTA buses or other modes of transportation. In such extensions, buses or other vehicles or points of access can be equipped with a smart card reader attached to the existing fare box/ticket validator 240. Transactions would be transmitted to the host system in real time over a wireless link. Alternatively, transactions would be stored within the equipment and downloaded to the host system when the bus returned to base Further, for example, the principles of AFC solution are readily extendable to implementations of the Host plus Smart Ticketing Application on PayPass Card architecture and the Host plus Distributed Entitlements architecture, which for brevity are not described in further detail herein.

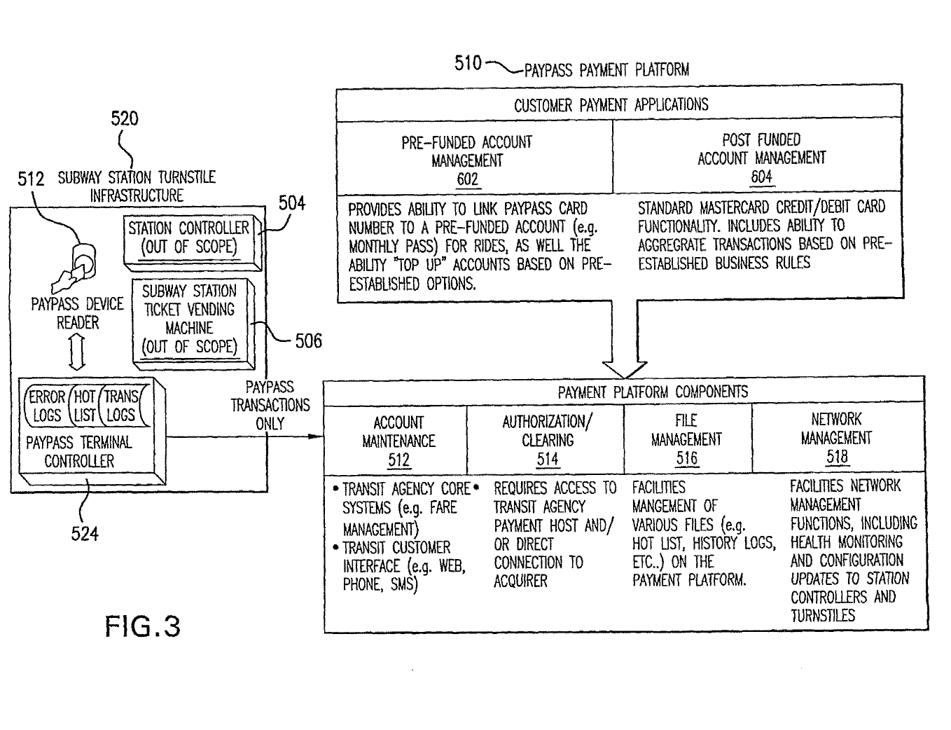

FIG. 3 shows the desired or required functions of the PayPass Transit Payment Platform 510 and the Subway Turnstile Infrastructure 520 associated with a demonstration of a PayPass based AFC solution in MTA/NY Transit. Similarly, Appendix C lists the functions and processing steps at each of the key components.

Subway Turnstile Infrastructure 520: All PayPass reader 522 and terminal 524 hardware and software preferably comply with published MasterCard PayPass specifications. PayPass readers 522 and terminals 524 preferably store and send information securely (e.g., in encrypted format) to prevent unauthorized access to the information. PayPass readers 522 and terminals 524 preferably are able to store or log two weeks worth of information in the event of a communications failure. Once these logs (e.g., error and transaction logs) are full, the data may not be overwritten until the logged information is uploaded from terminal 524. When communicating with the PayPass Transit Payment Platform 510, PayPass readers 522 and terminals 524 preferably provide device health information (e.g. that the device functioning correctly).

PayPass Transit Payment Platform 510: PayPass Transit Payment Platform 510 processes only PayPass transactions for turnstile access. All existing turnstile access legacy functions may continue to utilize existing transit agency infrastructure (e.g., station controller 504, ticket vending machine 506).

PayPass Transit Payment Platform 510 has applications for management of activities associated with PayPass transactions. These applications may include customer account management 602 and 604, account maintenance 512, payment-processing 516, file management 516, and network management 518 applications. PayPass Transit Payment Platform 510 may interact with MTA systems in support of processing PayPass transactions. PayPass Transit Payment Platform 510 may have appropriate management reporting functions for reporting daily activity (e.g.: authorizations obtained, transactions settled for funding, turnstile activity, etc.) to MTA.

PayPass Transit Payment Platform 510 has customer account management applications 602 and 604 for managing pre-funded and post-funded customer accounts, respectively. Transactions on the two types of account have different payment processing flows (i.e. transaction authorization and clearing flows).

PayPass Transit Payment Platform 510 preferably has the ability to link a PayPass card number to a pre-funded account for admittance through the turnstiles (pre-registration). Funding options may include auto loading, cardholder requested website reloads, SMS, etc. Further, PayPass Transit Payment Platform 510 preferably has a mechanism for cardholders to establish and maintain their pre-funded accounts. PayPass Transit Payment Platform 510 may provide a web based customer interface to allow cardholders to obtain ride history relating to aggregated post-funded transactions and/or pre-funded transactions, and transaction history associated with pre-funded account “top-up” activity. The web based customer interface also may allow cardholders to enroll and un-enroll for pre-funded accounts.

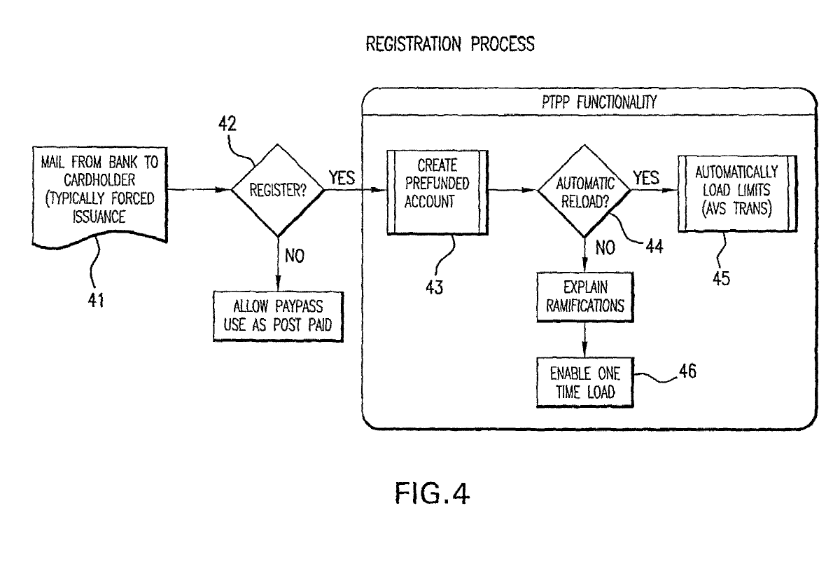

FIG. 4 shows a process 400 by which a customer who is mailed a PayPass card by an issuing bank can pre-register the PayPass card for use on a transit system, and link the card to a pre-funded transit account. At step 41 of process 400, the bank mails the PayPass card to the cardholder. At step 42, the cardholder may elect to register the card with the transit system. If the cardholder does not elect to register the card, the cardholder can still use the card for post-paid fare transactions on the transit system. If the cardholder elects to register the card, PayPass Transit Payment Platform 510 at step 43 sets up a pre-funded account associated with the card at an Automated Credit Service (ACS). The cardholder may further choose at step 44 to activate automatic reload features for the pre-funded account. If the cardholder does not choose to activate automatic reload, a pre-funded account is assigned a one-time value (step 46). Conversely, if the cardholder chooses to activate automatic reload features, account load limits are set up for automatic reloading at step 45. Step 45 may utilize a conventional address verification service (AVS) to check cardholder qualifications. The issuing bank may be notified if for three consecutive enrollment attempts the AVS check fails. However, the failing card may not be automatically hot listed. The issuing bank will have the necessary information and may choose to either hot list the card or allow the AVS checking parameters to be reset.

When pre-registering a card, PayPass Transit Payment Platform 510 may have access to the transit agency's fare rules (see e.g., Appendix A) allowing cardholders the choice of transit agency defined fare options (i.e. discount bulk purchase, buy 5 get one free, etc.).

PayPass Transit Payment Platform 510 preferably has the ability to perform authorization and clearing functions related to “top-up” activity for pre-funded accounts. The transit agency may be the merchant for these transactions and the existing merchant/acquirer relationships that are already in place can be utilized. PayPass Transit Payment Platform 510 may maintain and manage the balance for all pre-funded accounts. If a pre-registered card account balance is depleted and not reloaded, the card will be added to the negative file. A cancellation facility may be provided for cardholders who may decide that they no longer wish to use the pre-funded functionality but would rather use the post-funded functionality. If the auto load function has been set up previously, the cardholder may be given the choice of canceling only the auto load function or both the auto load function and the pre-funded account itself. Pre-funded accounts may allow “pass back”, for example, up to six (6) rides in 18 minutes. Once a pre-funded PayPass device is reported lost, the cardholder may be able to get any remaining value transferred to a new PayPass account.

For post-funded accounts, PayPass Transit Payment Platform 510 preferably has the ability to aggregate payment card transactions for clearing and authorization at a later time based on a set of pre-defined business rules. In general, an authorization amount may be different than the aggregated amount. For a demonstration project, MasterCard, the transit agency and the card issuer may jointly define the business rules. Post-funded accounts may allow “pass back”, for example, up to six (6) rides in 18 minutes.

The authorization procedures for post-funded transactions may be as follows:
At the beginning of any transaction, PayPass Transit Payment Platform 510 may check if the card used at a turnstile has a pre-funded account already set up, if no pre-funded account is found the transaction may be considered post-funded; and
For the first post-funded transaction, PayPass Transit Payment Platform 510 may perform an authorization. This authorization may be for the amount described in the aggregation business rules below. If the issuer declines this authorization request, the account may be added to the negative file.
Once this authorization is obtained, the card can be used in the transit system according to suitable business rules.

A suitable business rule for aggregation of post-funded transactions requires the aggregated transaction amounts to be sent for clearing when any of the following exemplary conditions are met or exceeded:
(1) 10 rides have been taken,
(2) a maximum of one half of a month has passed since the first ride. On the 1st and 15th of the month, the post paid accumulated accounts that have been open for at least 2 weeks may be posted.
(3) the card is hot listed after a transaction has been accepted but prior to the aggregated amount being sent for authorization.

These exemplary conditions are parameter based. The parameters may be set through PayPass Transit Payment Platform 510 and downloaded to the PayPass reader/terminal. After any one of the aggregation business rule conditions have been met, PayPass Transit Payment Platform 510 may create a clearing transaction. For the next (post settlement) use of the card, PayPass Transit Payment Platform 510 may treat the card as unknown and process an authorization request.

PayPass Transit Payment Platform 510 preferably has access to a network for performing authorization and clearing functions. It is assumed that the transit agency is the merchant for these transactions and that existing merchant/acquirer relationships are already in place. PayPass Transit Payment Platform 510 preferably may provide an audit trail of all transactions and interactions occurring on the platform and at the turnstiles. This data may be exportable to the designated support systems and file formats.

PayPass Transit Payment Platform 510 maintains and manages the positive (entitlement) and negative files. The negative file is used to list hot cards (e.g., lost, stolen, and “Never Received in Issuance” (NRI) cards). The negative file is downloaded to terminals 524 on a regular basis, preferably as frequently as every four hours. PayPass Transit Payment Platform 510 may update the negative file multiple times per day based upon a data feed from the card issuer, a data feed from MasterCard, and/or PayPass Transit Payment Platform activity (e.g., a card that has depleted all of its pre-funded account balance may be added to the negative file). Cards may be taken off the hot list when a request is made by the issuer bank to remove a card from the hot list (e.g., when a customer in arrears, who was previously added to the hot list, pays their bill), or when a depleted pre-funded account is funded again.

PayPass Transit Payment Platform 510 and the terminal systems may maintain a velocity file to track usage of the PayPass devices. This velocity file may be sent to the transit agency multiple times during the day. The PayPass Transit Payment Platform may be required to communicate with the terminals, e.g., over a dial up phone line provided and maintained by the MTA.

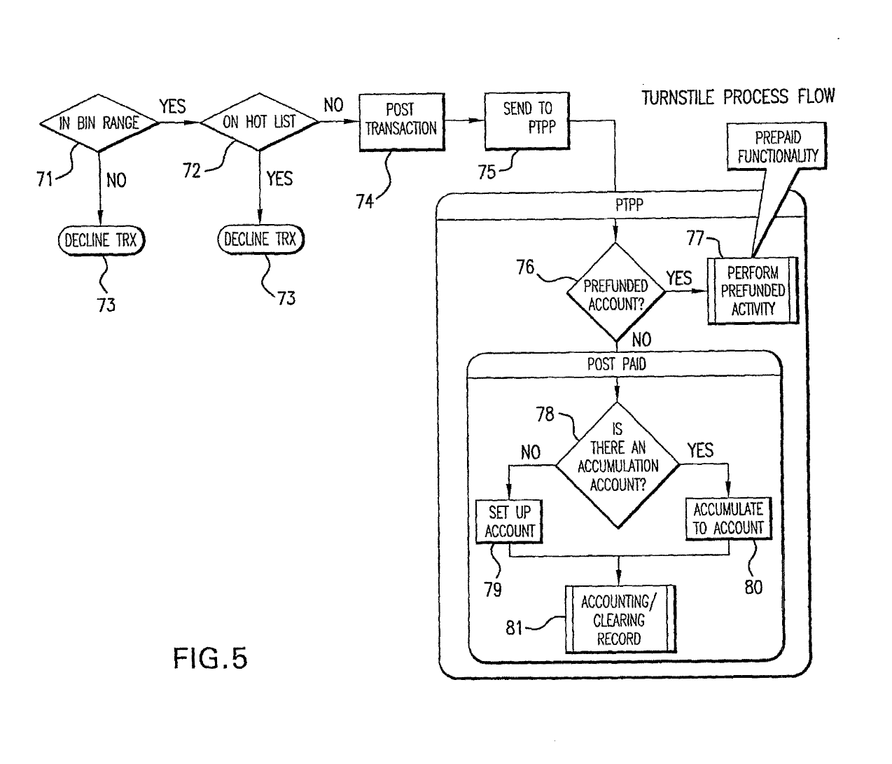

FIG. 5 shows the exemplary steps involved in the AFC process 700 when a customer presents a PayPass card for fare payment at a transit system's card reader. At step 71, the card's bank identification number (BIN) is checked. If the BIN is in range, at optional step 72 the card is checked against the hot list. If the result of the checks at either step 71 and 72 are unfavorable, the transaction is declined (step 73). If the result of the checks at steps 71 and 72 are favorable, a transaction is posted (step 74) and sent to the PayPass Transit Payment Platform for processing (step 75).

The PayPass Transit Payment Platform at step 76 determines if there is a pre-funded account associated with the card. In case there is a pre-funded account, the PayPass Transit Payment Platform at step 77 performs pre-funded account activity. In case there is no pre-funded account associated with the card, the PayPass Transit Payment Platform at step 78 determines if there is an accumulation or aggregation account associated with the card. In case there is no accumulation account associated with the card, the PayPass Transit Payment Platform at step 79 sets up an accumulation account associated with the card. In case there is an accumulation account associated with the card, the PayPass Transit Payment Platform at step 80 accumulates the transaction to the accumulation account. Lastly the PayPass Transit Payment Platform step 81 prepares an accounting/clearing record for aggregation when a business rule condition is triggered.

In accordance with the present invention, software (i.e., instructions) for implementing the aforementioned AFC solutions can be provided on computer-readable media. It will be appreciated that each of the steps (described above in accordance with this invention), and any combination of these steps, can be implemented by computer program instructions. These computer program instructions can be loaded onto a computer or other programmable apparatus to produce a machine, such that the instructions, which execute on the computer or other programmable apparatus, create means for implementing the functions of the aforementioned AFC solutions. These computer program instructions can also be stored in a computer-readable memory that can direct a computer or other programmable apparatus to function in a particular manner, such that the instructions stored in the computer-readable memory produce an article of manufacture including instruction means which implement the functions of the aforementioned AFC solutions. The computer program instructions can also be loaded onto a computer or other programmable apparatus to cause a series of operational steps to be performed on the computer or other programmable apparatus to produce a computer implemented process such that the instructions which execute on the computer or other programmable apparatus provide steps for implementing the functions of the aforementioned AFC solutions. It will also be understood that the computer-readable media on which instructions for implementing the aforementioned AFC solutions are be provided, include without limitation, firmware, micro controllers, microprocessors, integrated circuits, ASICS, and other available media.

One skilled in the art will appreciate that the present invention can be practiced by other than the described embodiments which are presented for purposes of illustration and not of limitation, and that the present invention is limited only by the claims which follow.

### APPENDIX A

### MTA FARE STRUCTURE

Single-ride—Full Fare—$2

Single-ride—Reduced Fare—$1
Pay-per-ride metroCard (pre-funded journeys at either Full or Reduced Fare)
Buy as many rides as you want from $4 to $80
Put $10 or more on your card and receive a 20 percent bonus
Automatic free transfer between subway and bus, or between buses
(no transfers from subway to subway or to the bus route on which you started)
(refill as often as you like, until card expires)
(can be used to pay for up to 4 people at a time)

Unlimited Ride MetroCard (pre-funded, unlimited journeys in a given time period)
1-Day Fun Pass
7-Day
30-Day
7-Day Express Bus Plus
30-Day Unlimited Ride (JKF AirTrain Only)
(no refills—purchase a new card for each new period)
cannot be used at the same subway station or on the same bus route for 18 minutes)

(can only be used by one person at a time)

### APPENDIX B

TABLE
Possible Types of Card and Transit Payments Supported

| | | | PayPass | Powered by |
|---|---|---|---|---|
| | | | MasterCard | PayPass |
| | | | MetroCard | MetroCard |
| | PayPass | | MTA METROCARD/ | MTA PRIVATE |
| | MasterCard | | MASTERCARD | LABEL PREPAID |
| | MASTERCARD | | PAYPASS | CARD POWERED |
| | PAYPASS | | Bank/MTA co-brand | BY PAYPASS |
| | Bank PayPass Card | | PayPass Card | MTA PayPass Card² |
| | Credit or debit | | Credit or debit | Prepaid ‘Private Label’ |
| | Unregistered | Registered | Registered | Registered |
| Single Ride - | Y¹ | N | N | N |
| Full Fare | | | | |
| Singe Ride - | N | N | N | N |
| Reduced Fare | | | | |
| Pay-per-ride³ | N | Y | Y | Y |
| (value based) - | | | | |
| Full Fare | | | | |
| Pay-per-ride³ | N | Y | Y | Y |
| (value based) - | | | | |
| Reduced Fare | | | | |
| Unlimited ride³ | N | Y | Y | Y |
| (time based) | | | | |

| | | | |
|---|---|---|---|
| Use outside | Y | Y | N |
| MTA at | | | |
| MasterCard | | | |
| merchants | | | |
| Usage | Named account | Named account | Named account holder |
| | holder only | holder only | (? Allow use by anyone |
| | | | with account holder's |
| | | | permission ?) |

Notes to Table
¹Unregistered cards may perform a limited number of single rides per month. Once the limit is reached, registration may be required
²MTA PayPass cards may be issued on behalf of the MTA by a partner e.g. MasterCard bank
³Pay-per-ride and Unlimited ride functionality is supported by a transit payments host system platform

### APPENDIX C

### Functions/Processing of Key Components

This appendix is a non-exhaustive, illustrative list of the processing impacts on key system components.

### Gate Processing

read card (PAN+Expiry Date+CVC)

verify card (local)
PAN checksum OK
check expiry date not exceeded
check card data against local negative file

IF verification OK THEN open gate

Format transaction record
Station+Gate+Card Data+Transaction Type (entry only)+Date/Time Stamp

### Station Controller Processing

Receive Negative File

Respond to negative file enquiries

Store and Forward Transaction Records
Route PayPass Transaction to New Transit Payment Platform
Route existing MetroCards Transactions to current Cubic platform

### Transmit Payment Platform Processing

Table Maintenance
Fares
Active stations
Gates within system—by fare control area
Card Types
   Fare Plan
   Travel Rules

Register Card+Fare Plan

Card Account/Entitlement

Cardholder inquiry on account information

Update Fare Plan

Block Card (e.g.: lost/stolen)

Negative File Maintenance
Add new entries
Cleanup entries

Distribute Negative File

Receive/Validate Transaction Batch
Validate Batch
Validate Transaction
Sort (PAN, Date/Time, Station/Gate)

Process Transaction Batch (note 1)
Create Journey Transactions & Calculate Journey Fare
(Handle Exceptions)
Process pay-per-ride transactions
Process unlimited ride transactions
Process single ride transactions
(Questions if there is more than one credit/debit journey could aggregate?)

Process reloads from rePower

Acquirer Interface (for debit/credit transactions)

Risk Management/Fraud Detection

Settlement
With MTA
With Acquirer
With rePower

Customer service

What is claimed is:

1. A method for automated fare collection in a transit system, the method comprising:
using an RFID-enabled card reader coupled to a terminal controller to read a contactless payment card presented by a customer to gain access to gated pay areas of the transit system;
evaluating the read contactless payment card against a file having list of cards and accordingly granting or denying the customer access to gated pay areas of the transit system;
preparing and communicating a card transaction record to a transit payment platform; and
then at the transit payment platform, processing the card transaction record so that the transit system can automatically collect a fare for the customer granted access to the transit system pay area.

2. The method of claim 1 further comprising communicating the file with the list of cards from the transit payment platform to terminal controller coupled to RFID-enabled card reader, wherein the list of cards comprises cards that are lost, stolen and delinquent.

3. The method of claim 1, wherein processing the card transaction record at the transit payment platform comprises authorization, clearing and settlement of a card transaction over a commercial payment-by-card electronic network linked to an issuer of the contactless payment card presented by a customer.

4. The method of claim 3 further comprising conforming to open ISO industry standards for contactless payment cards and transaction payment processing.

5. The method of claim 3 wherein authorization, clearing and settlement of the card transaction over a commercial payment-by-card electronic network linked to an issuer of the contactless payment card presented by a customer further comprises authorization of aggregated card transactions.

6. The method of claim 1, wherein processing the card transaction record at the transit payment platform so that the transit system can automatically collect a fare for the customer granted access to the transit system pay area comprises determining whether the contactless payment card presented by the customer is an unregistered card or previously registered card associated with a pre-funded transit payment account.

7. The method of claim 6, further comprising:
for an unregistered card, setting up a fare aggregation account; and
for previously registered card, setting a fare as per a pre-registration fare schedule

8. The method of claim 6, wherein setting up a fare aggregation account for an unregistered card comprises:
obtaining authorization or approval for setting up a fare aggregation account for the card; and
if the card is approved, setting up a fare aggregation account with rules on when an aggregated transaction must be posted for clearing and settlement;
wherein the rules include at least one of a rule on an aggregation amount limit, a rule on an aggregation time limit; a rule on aggregation account status when the card is lost, stolen and delinquent, and a rule on aggregation account status if the card is later registered.

9. The method of claim 6, wherein for a registered card associated with a pre-funded transit payment account processing the card transaction record at the transit payment platform so that the transit system can automatically collect a fare for the customer granted access to the transit system pay area comprises checking the balance of the pre-funded transit payment account and obtaining a fare payment from the pre-funded transit payment account.

10. The method of claim 9, wherein when the balance of the pre-funded transit payment account is insufficient to obtain the fare payment from the pre-funded transit payment account the method further comprises adding the card to a list of cards that are lost, stolen and delinquent.

11. The method of claim 6, wherein the pre-funded transit payment account is a ride entitlement account and checking the balance of the pre-funded transit payment account comprises checking availability of a ride entitlement and obtaining a fare payment from the pre-funded transit payment account comprises deducting a ride entitlement from the account.

12. The method of claim 1, wherein processing the card transaction record then at the transit payment platform so that the transit system can automatically collect a fare for the customer granted access to the transit system pay area comprises implementing a transit system fare schedule.

13. The method of claim 1, wherein processing the card transaction record so that the transit system can automatically collect a fare for the customer granted access to the transit system comprises calculating the fare after the cardholder is granted access.

14. A system for automated fare collection in a transit system for collecting fares from a customer presenting an RFID-enabled smart card issued by a commercial card issuer to access a transit system pay area, the system comprising:
a transit payment platform;
an RFID-enabled card reader disposed at gate leading to the transit system pay area, the card reader configured to contactlessly read the smart card presented by the customer;
a terminal controller interfaced with the card reader, the terminal controller and the card reader configured to accept or reject the smart card read by the card reader against a file having list of cards and to accordingly grant or deny access to the customer through the gate, and further configured to generate and communicate a card transaction record to the transit payment platform;
wherein the transit payment platform is configured to process the card transaction record so that the transit system can automatically collect a fare the customer granted access to the transit system pay area.

15. The system of claim 14, wherein the transit payment platform comprises an authorization/clearing application linked to a payment-by-card electronic network for authorization, clearing and settlement of payment card transactions.

16. The system of claim 15, wherein the smart card and the payment-by-card electronic network conform to open ISO industry standards for contactless payments.

17. The system of claim 14, wherein the transit payment platform has a file application designed maintain the list of cards that includes cards that are lost, stolen or delinquent.

18. The system of claim 14, wherein the transit payment platform comprises a file application designed to maintain the list of cards and associated fare and ride entitlements.

19. The system of claim 14, wherein the transit payment platform comprises a customer account management application, which can link the smart card to a pre-funded transit account.

20. The system of claim 19, wherein the transit payment platform comprises a customer payment application designed to process the card transaction as one of a pre-funded account transaction account and a post-funded account transaction.

21. The system of claim 14, wherein the transit payment platform comprises a network management application designed to provide configuration updates to the RFID-enabled card reader and the terminal controller.

22. The system of claim 14, wherein the transit payment platform comprises an account maintenance application designed to implement a transaction fare according to a transit system fare schedule.

23. The system of claim 14, wherein the transit payment platform comprises a transit customer interface designed to provide the customer interactive access to account features and transaction reports.
